(19) United States
(12) Patent Application Publication
(10) Pub. No.: US 2014/0333470 A1
(43) Pub. Date: Nov. 13, 2014

(54) Apparatus for Determining Fill Level by Means of a Helical Antenna

(71) Applicant: Endress + Hauser GmbH + Co. KG, Maulburg (DE)

(72) Inventor: Thomas Blodt, Basel (CH)

(73) Assignee: Endress + Hauser GmbH + Co. KG, Maulburg (DE)

(21) Appl. No.: 14/263,154

(22) Filed: Apr. 28, 2014

(30) Foreign Application Priority Data
May 7, 2013 (DE) 10 2013 104 699.1

(51) Int. Cl. G01F 23/284

(52) U.S. Cl. CPC G01F 23/284
USPC 342/124

(57) ABSTRACT

Apparatus for determining or monitoring fill level of a fill substance in a container, comprising: at least two antennas, wherein a first antenna transmits electromagnetic waves in the direction of the surface of the fill substance and a second antenna receives reflected waves; and at least one evaluation unit, which ascertains fill level in the container based on travel-time difference of transmitted and reflected electromagnetic waves, characterized in that the antennas are helical antennas, in order to transmit, respectively to receive, circularly polarized electromagnetic waves and the evaluation unit detects a rotational direction change between the transmitted wave and the reflected wave.

The invention relates to an apparatus for determining or monitoring fill level of a fill substance in a container as defined in the preamble of claim 1.

In fill level measurement, microwaves are transmitted by means of an antenna to the surface of a fill substance and the echo waves reflected on the surface are received. The echo waves are presented as an echo function, from which travel time is determined. From the travel time, the separation between the surface of the fill substance and the antenna is determined.

All known methods can be applied, which enable measurement of relatively short distances by means of reflected microwaves. The best known examples are pulse radar and frequency modulation continuous wave radar (FMCW radar).

In pulse radar, short microwave transmission pulses, referred to in the following as waves, are periodically transmitted. These are reflected from the surface of the fill substance and received back after a distance dependent travel time. The received signal amplitude as a function of time is referred to as the echo function. Each value of this echo function corresponds to the amplitude of an echo reflected at a certain separation from the antenna.

In the FMCW-method, a continuous microwave is transmitted, which is periodically linearly frequency modulated, for example, according to a sawtooth function. The frequency of the received echo signal has, consequently, compared with the instantaneous frequency, which the transmission signal has at the point in time of the receipt, a frequency difference, which depends on the travel time of the echo signal. The frequency difference between transmission signal and received signal, which can be won by mixing the two signals and evaluating the Fourier spectrum of the mixed signal, corresponds, thus, to the separation of the surface of the fill substance from the antenna. Furthermore, the amplitudes of the spectral lines of the frequency spectrum won by the Fourier transformation correspond to the echo amplitudes. This Fourier spectrum is, consequently, in this case, the echo function.

Fill level measuring devices working with microwaves are applied in many branches of industry, e.g. in the chemicals industry and in the foods industry. Typically, it is the fill level in a container that is measured. These containers usually have an opening, where a nozzle or a flange is provided for securement of measuring devices.

Depending on application, fill level measuring technology usually involves use of parabolic-, horn- rod- or patch antennas. Horn antennas are basically so constructed that a funnel shaped metal horn is formed on a hollow conductor in the fill substance facing direction. The construction of a parabolic antenna can be described in simplified manner in the following way: the microwaves are guided in a hollow conductor, radiated directly, or by means of a reflector, and/or coupled back in the focal point of the parabolic mirror. A rod antenna is composed basically of a hollow conductor, which is filled at least partially with a rod of a dielectric and has a coupling structure in the form of a taper or cone facing in the direction of the fill substance. These three freely radiating antenna types are usually fed via a coaxial line, which is connected to an exciter element protruding into the hollow conductor.

A helical antenna is a helically shaped antenna for transmitting and receiving circularly polarized electromagnetic waves. The helical antenna is composed, in the case of unsymmetric (coaxial) supply, of one, or, in the case of symmetric supply, of two, conductors (band or wire) coiled into the shape of a screw.

The coil antennas likewise partially referred to as helical antennas are composed completely or partially of a single ply cylindrical coil, which has, however, dimensions, which are small compared with the wavelength. These antennas are, in principle, shortened quarter wave dipoles.

The winding direction of the helical antenna determines the direction of rotation of the radiated wave. Analogously, in the case of a helical antenna, those electromagnetic waves are received with the least loss, which have the same direction of rotation, as the winding direction of the helical antenna. Waves, which have another direction of rotation than the winding direction of the helical antenna, are, in contrast, received strongly suppressed. A helical antenna is able to receive waves linearly polarized in any direction. Therefore, they are often applied also in cases, where waves of undefined linear polarization are to be received.

EP 2 060 883 A1 describes a fill-level sensor, which has a first antenna for transmitting a transmission signal to a surface of the fill substance and a second antenna for receiving a signal reflected from the surface of the fill substance. Furthermore, the fill-level sensor includes a housing, which serves as outer shell for accommodating the first and second antennas. Furthermore, the housing has a cylindrical or conical external form, wherein the first and second antennas are embodied as horn antennas.

The known fill-level sensor receives the transmitted electromagnetic waves without paying attention to where they were reflected. The echo waves can be from the surface of the fill substance or a wall of the container or from interfering features, such as stirring mechanisms or the like.

An object of the invention is to provide a fill-level sensor, which ascertains a dependable value of fill level.

This object is achieved by the subject matter of the invention. The subject matter of the invention concerns an apparatus for determining or monitoring fill level of a fill substance in a container, comprising: at least two antennas, wherein a first antenna transmits electromagnetic waves in the direction of the surface of the fill substance and a second antenna receives reflected waves; and at least one evaluation unit, which ascertains fill level in the container based on travel-time difference of transmitted and reflected electromagnetic waves,

characterized in that the antennas are helical antennas, in order to transmit, respectively to receive, circularly polarized electromagnetic waves and that the evaluation unit detects a rotational direction change between the transmitted wave and the reflected wave.

If a circularly polarized wave is reflected only on the surface of the fill substance, the direction of rotation of the wave changes. If a circularly polarized waves is reflected on the surface of the fill substance and on one additional object, such as the container wall or a stirrer, the direction of rotation of the wave changes two times and the wave has at the receiver the same direction of rotation as at the transmitter. This means that a change of the direction of rotation of the circularly polarized waves results in the case of an odd number of reflections and no change of the direction of rotation of the circularly polarized waves results in the case of an even number of reflections. As a result, the circularly polarized waves, which arrive at the receiver with the same direction of rotation as when they were transmitted from the transmitter, are not used for the travel-time measurement, because they were reflected on the surface of the fill substance and on at least one additional location. In this way, a part of the waves, which can corrupt the travel-time measurement, can be eliminated.

In a further development, two antennas are provided, wherein a first antenna is embodied as a transmitting antenna and a second antenna as a receiving antenna, wherein the first antenna has a polarization direction opposite to that of the second antenna. The opposite polarization direction is achieved by a respectively opposite winding direction of a helical antenna.

If the transmitting and receiving antennas have opposite winding directions, the receiving antenna only receives circularly polarized waves, which have an opposite direction of rotation relative to the transmitted, circularly polarized waves. Therefore, taken into consideration for the travel time determination are only the waves having an uneven number of reflections, while the disturbing, multiply times reflected waves are eliminated.

In a further development, three antennas are provided, wherein a first antenna is embodied as a transmitting antenna, and a second and a third antenna are embodied as receiving antennas, wherein the second antenna has a winding direction of the same sense as the first antenna and the third antenna has a winding direction opposite to that of the first antenna.

In an additional form of embodiment, three antennas are provided, wherein a first antenna is embodied as a receiving antenna and a second and a third antenna are embodied as transmitting antennas, wherein the second antenna has a winding direction of the same sense as the first antenna and the third antenna has a winding direction opposite to that of the first antenna.

In a further development, the windings of the antennas are conically embodied, especially they are cone shaped.

In a further development, the antennas are funnel shaped with two oppositely lying openings, and the electromagnetic waves exit from a first opening, which has a larger aperture area than a second opening.

In a further development, the antennas are funnel shaped with two oppositely lying openings, and the electromagnetic waves exit from a first opening, which has a smaller aperture area than a second opening.

In a further development, the antennas are at least partially filled with a dielectric, especially a synthetic material, e.g. a plastic.

In a further development, the antennas have a housing transmissive for electromagnetic waves.

In a further development, at least two of the antennas are isolated by means of a partition, so that electromagnetic waves of the two antennas do not superimpose within the housing.

The invention will now be explained in greater detail based on the appended drawing, the figures of which show as follows:

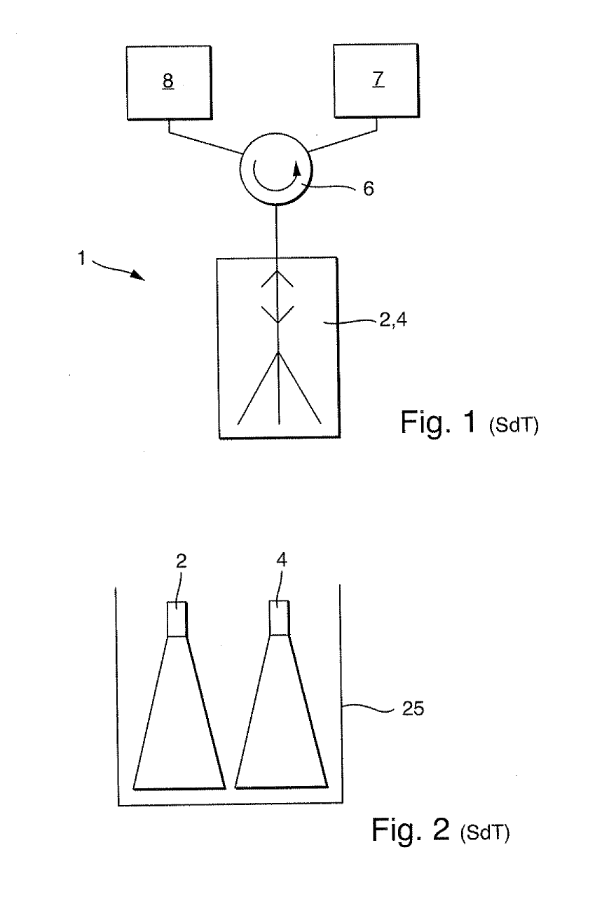

FIG. 1 a fill-level measuring device according to the state of the art with an antenna, which is suitable both for transmitting as well as also for receiving,

FIG. 2 a fill-level measuring device according to the state of the art with separate transmitting and receiving antennas,

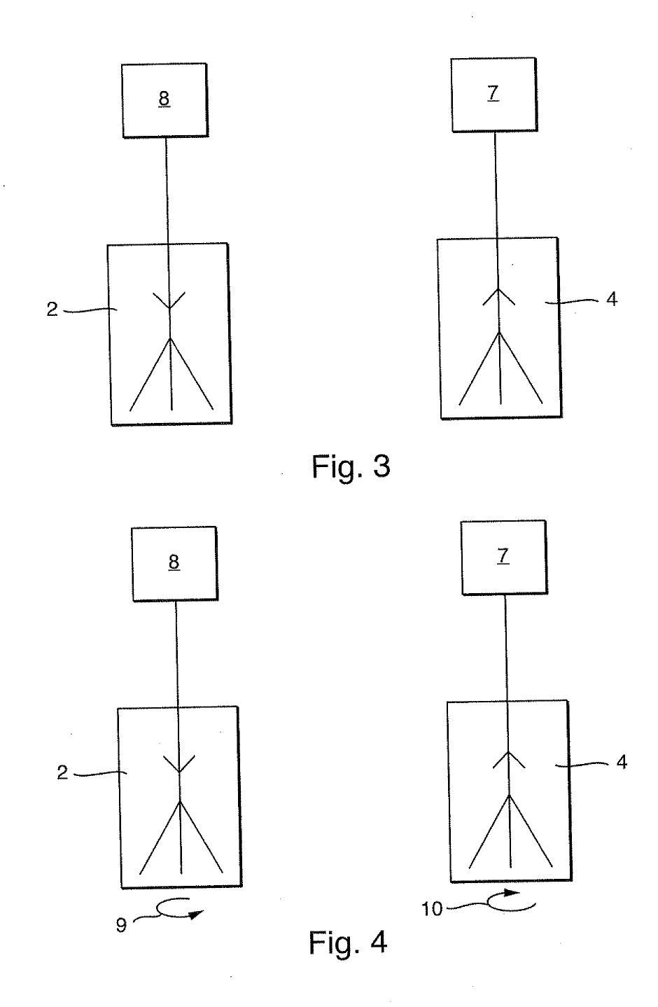

FIG. 3 an embodiment of the apparatus of the invention with separate transmitting and receiving circuits,

FIG. 4 an apparatus corresponding to FIG. 3 producing respectively circularly polarized waves,

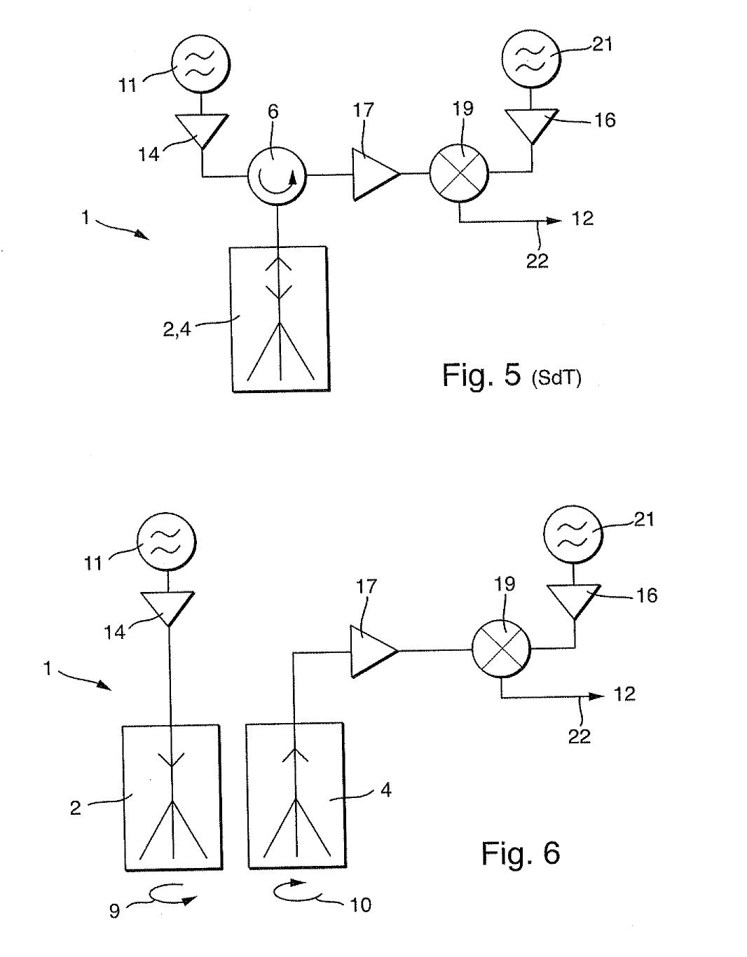

FIG. 5 a circuit of a fill-level measuring device according to the state of the art,

FIG. 6 an apparatus of the invention with two separate antennas, wherein a circularly polarized antenna is located in the transmission path and another polarized antenna in the receiving path,

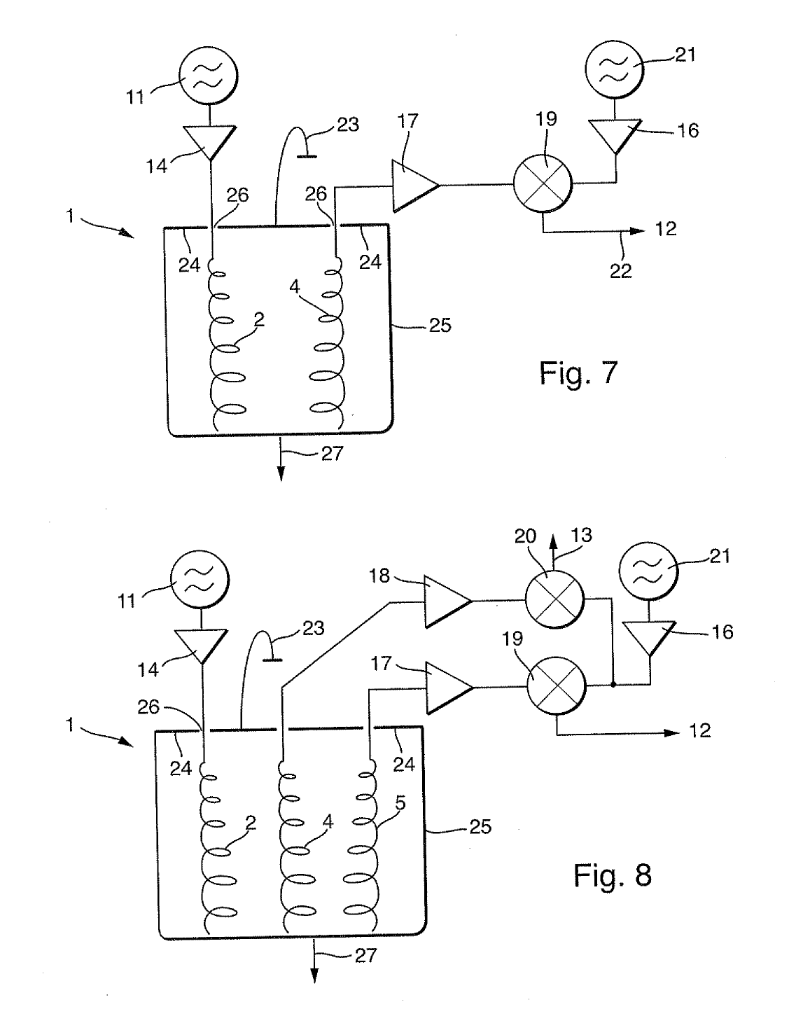

FIG. 7 an apparatus of the invention with two conical helix antennas, which are decoupled by means of a partition,

FIG. 8 an apparatus of the invention with three conical helix antennas, which are decoupled by means of two partitions,

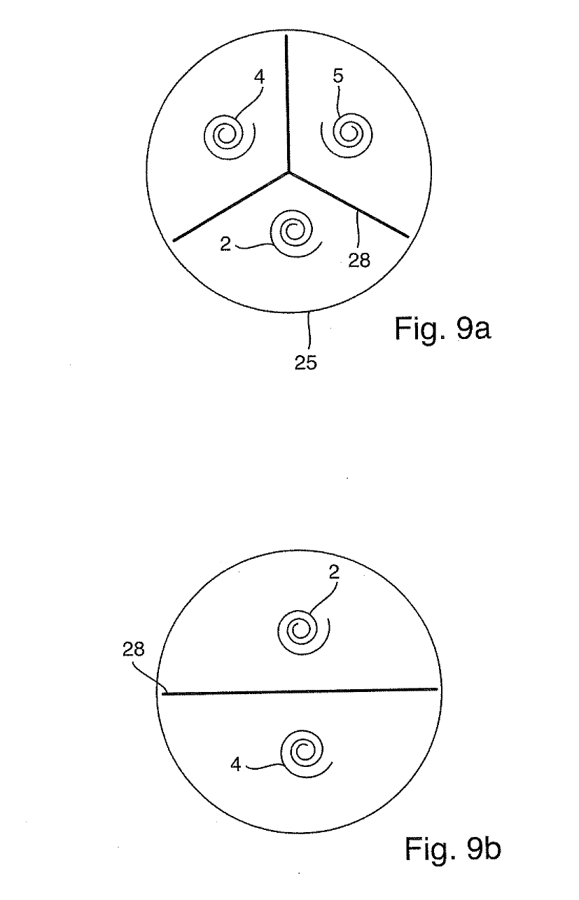

FIG. 9a three conical helix antennas in a dome, wherein the antennas are decoupled by means of three partitions,

FIG. 9b two conical helix antennas, which are decoupled by means of a partition,

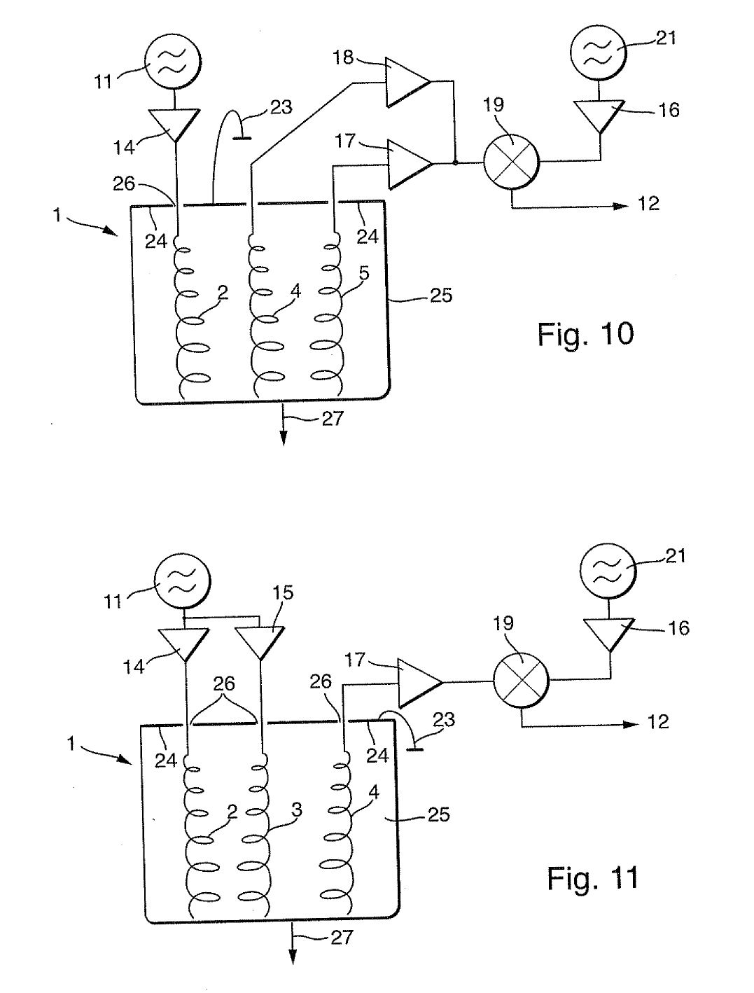

FIG. 10 an embodiment of the apparatus of the invention with one transmitting antenna and two receiving antennas,

FIG. 11 an embodiment of the apparatus of the invention with two transmitting antennas and one receiving antenna,

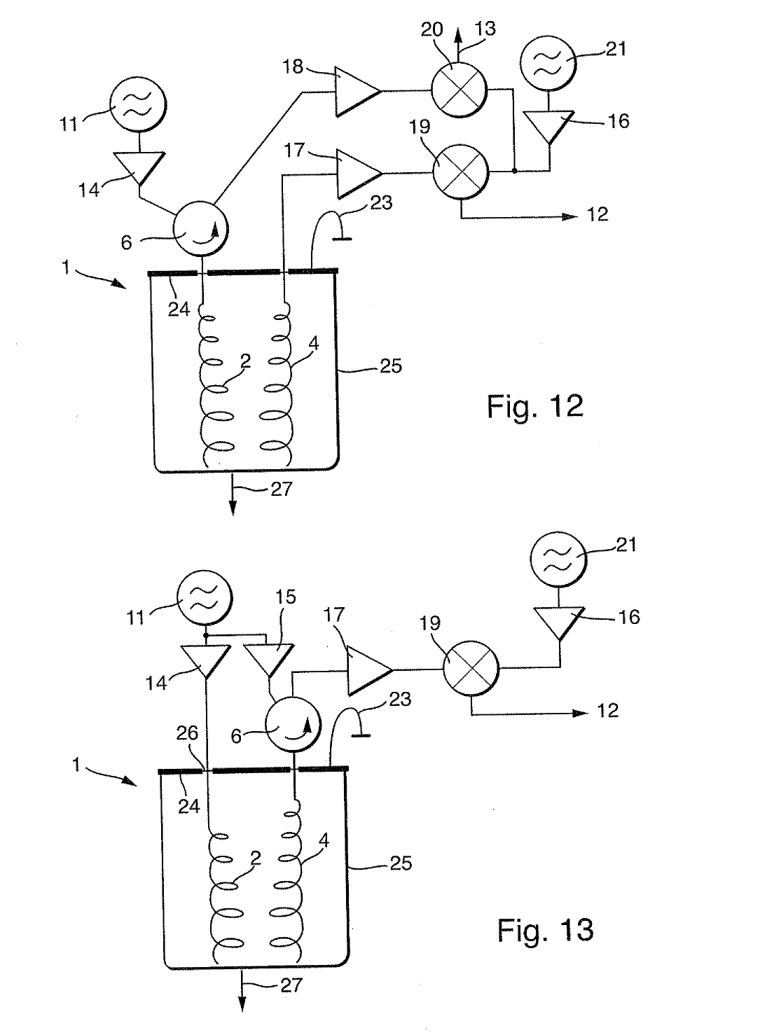

FIG. 12 an embodiment of the apparatus of the invention with a circulator at the transmitting antenna for forwarding the input signal to the output, and in order to use the transmitting antenna as a second receiving antenna, in order to prevent disturbance signals,

FIG. 13 an embodiment of the apparatus of the invention with a circulator at the receiving antenna, in order to use the receiving antenna as a second transmitting antenna and/or in order to superimpose the input signal with the output signal,

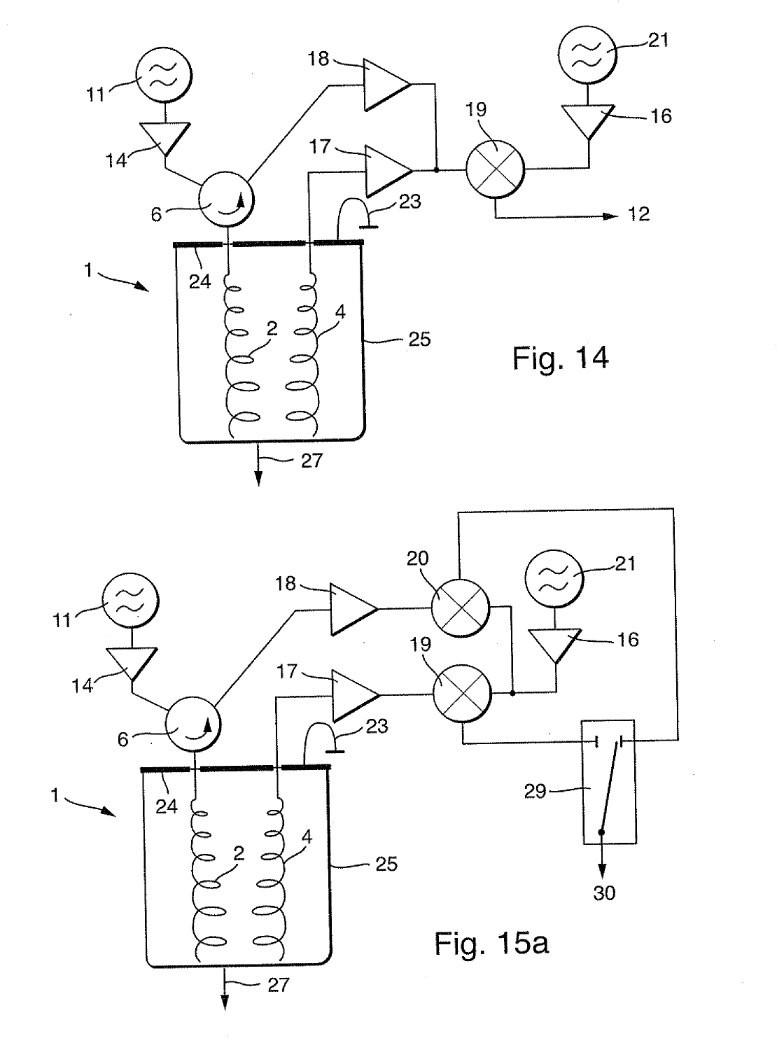

FIG. 14 an embodiment of the apparatus of the invention with a circulator at the transmitting antenna, in order to use the transmitting antenna as a second receiving antenna, in order to prevent disturbance signals and/or for forwarding the input signal to the output,

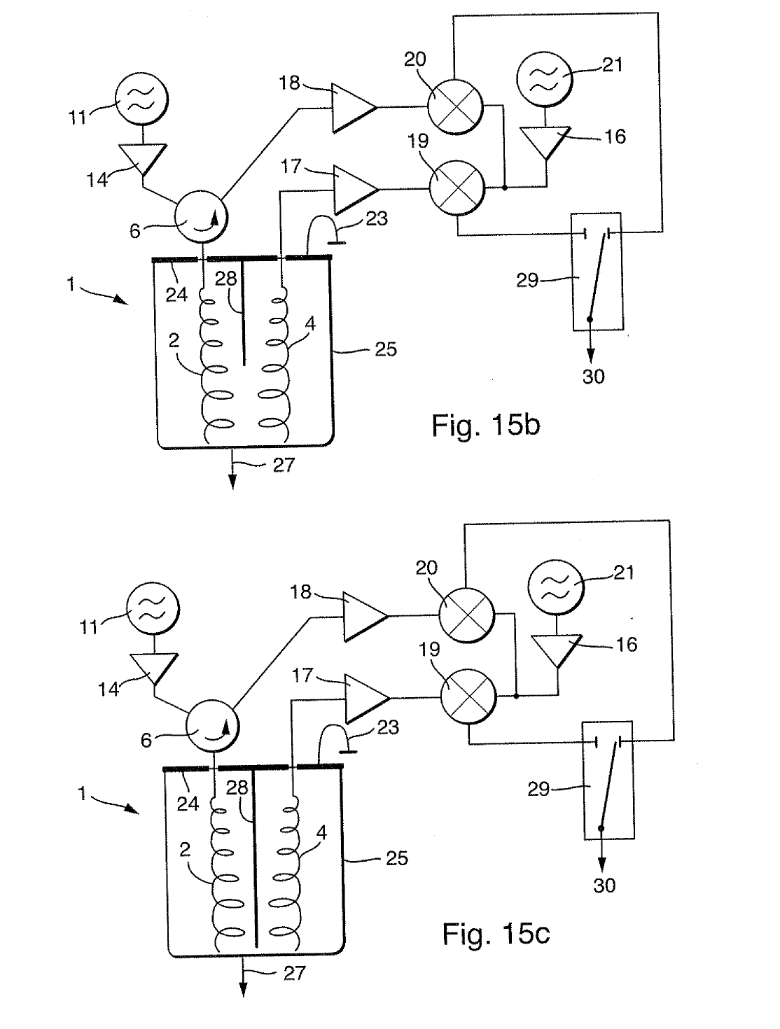

FIG. 15a an embodiment of the apparatus of the invention with two mixers, wherein the intermediate frequency signals of the two mixers can be combined via a switch to form a total intermediate frequency signal or be selected sequentially in time,

FIG. 15b an embodiment of the apparatus of the invention with two mixers, wherein a partition, which is half the size of the antennas, isolates the antennas,

FIG. 15c an embodiment of the apparatus of the invention with two mixers, wherein a partition, which is the same size as the antennas, isolates the antennas.

FIG. 1 shows a fill-level measuring device 1 according to the state of the art, such as sold by the assignee under the mark, MICROPILOT. An antenna 2, 4, which acts both as transmitting, as well as also receiving, antenna, is connected with a circulator 6 (for example, of type, FMR50, or type, FMR54). The circulator 6 leads, on the one hand, to the receiver circuit 7 and, on the other hand, to the transmitter circuit 8. An electromagnetic wave, which is received by the antenna 2, 4, is converted into electrical signals and forwarded to the circulator 6. The signal after passing twice through the circulator 6 suffers a power loss of about 6 dB.

FIG. 2 shows a schematic representation of an antenna arrangement according to EP 2060883 A1. A first horn antenna 2 and a second horn antenna 4 are arranged in a housing 25. The first horn antenna 2 transmits an electromagnetic wave, which is received by the second horn antenna 4. In such case, the second horn antenna 4 checks whether the received wave, has the same polarization plane as the transmitted wave.

FIG. 3 shows an embodiment of the apparatus 1 of the invention with separate transmitting and receiving circuits.

FIG. 4 shows an apparatus 1 corresponding to FIG. 3. A transmitter circuit 8 emits by means of a transmitting antenna 2 an electromagnetic wave with a first direction of rotation 9. A reflected wave of the transmitted wave is received by means of a receiving antenna 4. The reflected wave has a second direction of rotation 10, which is opposite the first direction of rotation 9 of the transmitted wave. The reflected wave is forwarded by means of the receiving antenna 4 to a receiver circuit 7.

FIG. 5 illustrates a circuit of a fill-level measuring device 1 according to the state of the art. The apparatus 1 includes a transmission oscillator 11, whose signal is sent by way of a first amplifier 14 to a transmitting/receiving separator, or directional coupler, 6. The transmitting/receiving separator, or directional coupler, 6 sends the signal to an antenna 2, 4, which converts the signal into electromagnetic waves and transmits the electromagnetic waves. The electromagnetic wave reflected on the surface of the fill substance is received by means of the antenna 2, 4 and sent via the transmitting/receiving separator, or directional coupler, 6 to a first receiving amplifier 17. The first receiving amplifier 17 forwards the signal to a mixer 19. Fed to the mixer 19 via a mixer-driver amplifier 16 is a further signal of a receiving oscillator 21. In this way, there arises on an output 22 of the mixer 19 according to the principle of a heterodyne receiver, among other things, an intermediate frequency signal 12, from which the travel time is determined.

The transmitting/receiving separator, or directional coupler, leads in the case of this embodiment as a directional coupler with unilaterally matched termination to a power loss of about 6 to 8 dB. With the application of a circulator, the power loss amounts to about 1 to 2 dB.

FIG. 6 shows an apparatus 1 of the invention. The apparatus 1 of the invention works with two separate antennas 2, 4, which are embodied as transmitting antenna 2 and receiving antenna 4. Since no circulator is required, no power loss occurs in the transmitting and receiving of the electromagnetic wave.

A concrete embodiment of the apparatus of the invention is shown in FIG. 7. The antennas 2, 4 are embodied as funnel-shaped, helical antennas, wherein the receiving antenna 4 has a winding direction opposite to that of the transmitting antenna 2. The antennas 2, 4 are both arranged in a dome 25, which is transmissive for electromagnetic waves. Dome 25 is pot shaped and is capped by means of a reflector plate 24, which functions as a kind of lid of the pot-shaped dome 25. Reflector plate 24 is at least partially, preferably completely, of an electrically conductive material, e.g. metal, which can reflect electromagnetic waves. The antennas 2, 4 are arranged in the dome 25 in such a way that a preferred wave propagation direction 27 is away from the reflector plate 24. Furthermore, the antennas 2, 4 have on an end opposite the wave propagation direction 27 electrical cable guides 26, which lead through the reflector plate 24 to the electronic components of the apparatus 1. Reflector plate is grounded by means of a signal ground 23. Dome 25 can also serve as galvanic isolation for the system on the process side.

If an electromagnetic wave is produced in the transmitting antenna 2, the electromagnetic wave leaves the transmitting antenna 2 as a circularly polarized wave due to the helical shape of the antenna. If the circularly polarized wave strikes the surface of the fill substance, this changes its direction of rotation. The reflected wave has, thus, an opposite direction of rotation as compared with the transmitted wave. The receiving antenna 4 has an opposite winding direction as compared with the transmitting antenna 2. Now the reflected wave has the same direction of rotation as the winding direction of the receiving antenna 4. As a result, the reflected wave is received by the receiving antenna 4 with especially low loss.

If, in contrast, the emitted wave is reflected on the surface of the fill substance and on an additional area, it has, after a double change of its direction of rotation, the same direction of rotation as the emitted wave. Since the reflected wave now has an opposite direction of rotation as the receiving antenna 4, the wave is received with especially high loss.

This allows the converse conclusion that an especially high loss receipt of the reflected wave must have an opposite direction of rotation as the winding direction of the receiving antenna 4 and an especially low loss receipt of the reflected wave must have the same direction of rotation as the winding direction of the receiving antenna 4.

Thus, the wave received with high loss has experienced an even number of reflections and the wave received with low loss has experienced an odd number of reflections. An even number of reflections shows that the wave was reflected on the surface of the fill substance and on at least one additional area.

Thus, the wave received with low loss is not taken into consideration for the travel time determination. In this way, waves corrupting the travel-time measurement can be eliminated. Due to the exponential decrease of amplitude upon each reflection, it can be ascertained which wave received with low loss has experienced only one reflection. Then only this wave is taken into consideration for travel time determination.

In the case of some waves, no one hundred percent change of the direction of rotation occurs upon reflection. Referenced to power, this is true for about 1% of the waves. This residue is received in the case of waves reflected with low loss.

FIG. 8 shows another embodiment of the apparatus 1 of the invention with three antennas 2, 4, 5, thus a transmitting antenna 2 and first and second receiving antennas 4, 5. All of these antennas are embodied as funnel-shaped helical antennas and are arranged in a dome 25 capped by means of a reflector plate 24. All three antennas 2, 4, 5 have a preferred wave propagation direction 27, which points away from the reflector plate 24. Cable guides 26 are arranged on ends of the antennas 2, 4, 5 opposite the preferred wave propagation direction 27 and lead via the reflector plate 24 to the electronic components of the apparatus 1. One electrical cable guide 26 leads from the transmitting antenna to a first amplifier 14 and then to a transmission oscillator 11, which produces the transmission signal. Electrical cable guides 26 lead from the first and second receiving antennas 4, 5 respectively to first and second receiving amplifiers 17, 18. The outputs of the first and second receiving amplifiers 17, 18 lead respectively to first and second mixers 19, 20. First mixer 19 provides the first and the second mixer 20 the second intermediate frequency signal 12, 13. The outputs of the first and second mixers 12, lead to a third amplifier 16 and then to a receiving oscillator 21.

The transmitting antenna 2 transmits a circularly polarized wave. If this wave experiences an odd number of reflections, the reflected wave reaches the dome 25 with an opposite direction of rotation. Since the first receiving antenna 4 has the same winding direction as the transmitting antenna 2, the wave is received by the first receiving antenna 4 after a one time reflection on a surface with an especially high loss. The second receiving antenna 5 has a winding direction opposite to that of the transmitting antenna 2. The wave is received by the second receiving antenna 5, consequently, with especially low loss. The electronic circuit can recognize such and uses this wave for travel-time measurement. Moreover, the difference between the signal of the first and second mixers 12, 13 can be taken into consideration for detection of the near range in the evaluation of an envelope curve.

If, in contrast, the transmitted wave is reflected on the surface of the fill substance and on an additional area, its direction of rotation does not change. This wave is received by the first receiving antenna 4 with low loss and by the second receiving antenna 5 with high loss and, consequently, is not taken into consideration by the electronic circuit for travel-time measurement.

FIG. 9a shows the three antennas 2, 4, 5 of the apparatus 1 illustrated in FIG. 8, as seen from the preferred wave propagation direction 27. The transmitting antenna 2 and the first and second receiving antennas 4, 5 form the vertices of an equilateral triangle. Dome 25 has a circularly shaped cross section. Partitions 28 isolate the three antennas 2, 4, 5 from one another, so that electromagnetic waves of any given antenna are not superimposed within the dome 25 on the electromagnetic waves of another antenna. In this way, a cross polarization between the antennas is prevented. Therefore, the partitions 28 must be electrically conductive.

FIG. 9b shows two antennas 2, 4 in a dome 25, such as they are arranged in the example of an embodiment corresponding to FIG. 7. A partition 28 isolates the two antennas 2, 4, so that electromagnetic waves of the one antenna are not superimposed within the dome 25 on the electromagnetic waves of the other antenna.

FIG. 10 shows the apparatus 1 of the invention corresponding to FIG. 8, with only a first mixer 19. The outputs of the first and second receiving amplifiers 17, 18 lead to the first mixer 19, wherein the output of the first mixer 19 leads to the third amplifier 16 and to the receiving oscillator 21. First mixer 19 supplies the first intermediate frequency signal 12. The received signals of the first and second receiving antennas 4, 5 can be let by means of the first and the second receiving amplifier 17, 18 alternately through, in order to minimize the influence of signals, which are not taken into consideration for travel time determination.

FIG. 11 shows another form of embodiment of the apparatus 1 of the invention. In the case of this form of embodiment, the apparatus 1 includes first and second transmitting antennas 2, 3 and one receiving antenna 4. The first transmitting antenna 2 has an opposite winding direction as compared with that of the second transmitting antenna 3. The second transmitting antenna 3 has a winding direction identical to that of the winding direction of the receiving antenna 4. All three antennas 2, 3, 4 are arranged in a dome 25, wherein the dome is closed with a reflector plate 24. The antennas 2, 3, 4 have a preferred wave propagation direction 27, which points away from the reflector plate 24. Arranged on an end of the three antennas 2, 3, 4 lying opposite the preferred propagation direction 27 are electrical cable guides 26, which lead to the outside of the dome 25. In this way, the first transmitting antenna 2 is connected with a first amplifier 14 and the second transmitting antenna 3 with a second amplifier 15, in both cases on the output sides of the amplifiers. The inputs of the first and second amplifiers 14, 15 are connected with a transmission oscillator 11. The receiving antenna 4 is connected with the input of a first receiving amplifier 17, wherein the first receiving amplifier 17 is connected output side with a first mixer 19. First mixer 19 is connected output side with a third amplifier 16, wherein the third amplifier 16 is connected input side with a receiving oscillator 21. Furthermore, the first mixer 19 provides the first intermediate frequency signal.

A signal from the transmission oscillator 11 is switched between the first amplifier 14 and the second amplifier 15. An option, however, would be to provide separate oscillators for the two transmitting amplifiers. In the case of application of the amplifier as a switch, the reaction (scattering parameters) should be as small as possible.

FIG. 12 shows another form of embodiment of the apparatus 1 of the invention, which has a construction similar to the form of embodiment in FIG. 7. The difference, on the one hand, is that the transmitting antenna 2 is connected to a circulator 6 and the circulator 6 to the first amplifier 14 and to the transmission oscillator 11. On the other hand, the circulator 6 is connected to a second signal path, which extends parallel to a first signal path of the receiving antenna 4. The first and the second signal paths extend, respectively, via the first and the second receiving amplifiers 17, 18 and, respectively, via the first and the second mixers 19, 20 and are then led together before reaching the third amplifier 16 and the receiving oscillator 21. The first and second mixers 19, 20 provide, respectively, the first and second intermediate frequency signals.

By comparing the first and second signal paths, likewise certain signals, which are not evaluated, respectively taken into consideration, for travel time determination, can be eliminated.

FIG. 13 shows another form of embodiment of the apparatus 1 of the invention, in the case of which the signal of the transmission oscillator 11 is forwarded input side to first and second amplifiers 14, 15. The first amplifier 14 feeds output side the transmitting antenna 2. The second amplifier 15 is connected output side with the circulator 6, wherein the circulator 6 is connected both with the receiving antenna 4 as well as also input side with the first receiving amplifier 17. On the output side, the first receiving amplifier 17 is connected with the first mixer 19. First mixer 19 leads, on the one hand, to the third amplifier 16 and then to the receiving oscillator 21. On the other hand, the first mixer 19 provides the first intermediate frequency signal 12. The first and second amplifiers 14, 15 are alternately switched between the conducting and blocking states, wherein the reactions of the first and second amplifiers 14, 15 in the blocking states should not exceed the cross polarization attenuation of the transmitting and receiving antennas.

FIG. 14 shows another form of embodiment of the apparatus 1 of the invention, which is constructed similarly to the form of embodiment in FIG. 12. In this form of embodiment, only one mixer 19 is used. In this way, the costs of a second mixer are saved. The first and second receiving amplifiers 17, 18 are both connected to the first mixer 19. First mixer 19 is connected on its output side with the third amplifier 16 and provides the first intermediate frequency signal. The first and second receiving amplifiers 17, 18 are alternately switched to the conduction and blocking states.

FIG. 15a shows another form of embodiment of the apparatus 1 of the invention, which is constructed similarly to the apparatus 1 of FIG. 12. The difference compared with the apparatus of FIG. 12 is that the first intermediate frequency signal 12 of the first mixer 19 and the second intermediate frequency signal 13 of the second mixer 20 are led together input side via a switch 29. The switch 29 provides thereby on its output side a total intermediate frequency signal 30, which is formed from the first intermediate frequency signal and the second intermediate frequency signal 13 by sequentially joining them together.

In this form of embodiment, a part of an exciter signal of the transmission oscillator 11 flows via the circulator 6 on a second signal path through the second receiving amplifier 18 and the second mixer 20. The signal of the second signal path is compared with a signal of the first signal path, which flows through the first receiving amplifier 17 and the first mixer 19 to the third amplifier 16 and the receiving oscillator 21. A switching between the first and the second signal path can occur by means of the first and second receiving amplifiers 17, 18. Comparison of the first and second signal paths allows identification of signals, which are not to be taken into consideration for travel time determination.

FIG. 15b shows another form of embodiment of the apparatus 1 of the invention according to FIG. 15a with a partition 28 between the transmitting antenna 2 and the receiving antenna 4. Partition 28 is about half as long as the antennas 2, 4.

FIG. 15c shows another form of embodiment of the apparatus 1 of the invention according to FIG. 15b with a partition 28 between the transmitting antenna 2 and the receiving antenna 4, wherein the partition 28 is about exactly as long as the antennas 2, 4.

The partitions 28 serve the purpose of attenuating cross polarization and assuring that the electromagnetic waves, which the transmitting antenna 2 transmits, are not superimposed within the dome 25 with the electromagnetic waves, which the receiving antenna 4 receives.

Furthermore, an option is to measure in a container with such an apparatus using a reflector, for example, at an angle of 45°. The electromagnetic waves are rotated in the transmitting path as well as in the receiving path, in each case, once by 180° in the polarization direction. The relationship between direct and multiply reflected signals remains, however.

### LIST OF REFERENCE CHARACTERS

1 apparatus
2 first antenna (first transmitting antenna)
3 second antenna (second transmitting antenna)
4 third antenna (first receiving antenna)
5 fourth antenna (second receiving antenna)
6 circulator, respectively transmitting/receiving separator, directional coupler
7 receiver circuit
8 transmitter circuit
9 first direction of rotation
10 second direction of rotation
11 transmission oscillator for producing the transmission signal
12 first intermediate frequency signal
13 second intermediate frequency signal
14 first amplifier
15 second amplifier
16 third amplifier
17 first receiving amplifier
18 second receiving amplifier
19 first mixer
20 second mixer
21 receiving oscillator
22 output signal with the distance information (envelope curve production)
23 signal ground
24 reflector(-plate)
25 dome
26 electrical cable guides
27 preferred wave propagation direction
28 partition
29 switch
30 total intermediate frequency signal

1-10. (canceled)

11. An apparatus for determining or monitoring fill level of a fill substance in a container, comprising:
at least two antennas, wherein a first antenna transmits electromagnetic waves in the direction of the surface of the fill substance and a second antenna receives reflected waves; and
at least one evaluation unit, which ascertains fill level in the container based on travel-time difference of transmitted and reflected electromagnetic waves, wherein:
said antennas are helical antennas, in order to transmit, respectively to receive, circularly polarized electromagnetic waves; and
said evaluation unit detects a rotational direction change between the transmitted wave and the reflected wave.

12. The apparatus as claimed in claim 11, wherein:
two antennas are provided;
a first antenna is embodied as a transmitting antenna;
a second antenna is embodied as a receiving antenna; and
said first antenna has a winding direction opposite to that of said second antenna.

13. The apparatus as claimed in claim 11, wherein:
three antennas are provided;
a first and a second antenna are embodied as first and second transmitting antennas;
a third antenna is embodied as a first receiving antenna; and
said first antenna has a winding direction of the same sense as said third antenna and said second antenna has a winding direction opposite to that of said first antenna.

14. The apparatus as claimed in claim 11, wherein:
that three antennas are provided;
a first antenna is embodied as a first transmitting antenna;
a third and a fourth antenna are embodied as a first and a second receiving antenna; and
said third antenna has a winding direction of the same sense as said first antenna and said fourth antenna has a winding direction opposite to that of said first antenna.

15. The apparatus as claimed in claim 11, wherein
the windings of at least one of the antennas is embodied conically, especially cone shaped.

16. The apparatus as claimed in claim 15, wherein:
at least one of the antennas is funnel shaped with two oppositely lying openings, and the electromagnetic waves exit from a first opening, which has a larger aperture area than a second opening.

17. The apparatus as claimed in claim 15, wherein:
at least one of the antennas is funnel shaped with two lying opposite openings, and the electromagnetic waves exit from a first opening, which has a smaller aperture area than a second opening.

18. The apparatus as claimed in claim 11, wherein:
at least one of the antennas is at least partially filled with a dielectric, especially a synthetic material.

19. The apparatus as claimed in claim 11, wherein:
at least one of the antennas has a housing transmissive for electromagnetic waves.

20. The apparatus as claimed in claim 11, wherein:
at least two of the antennas are isolated by means of a partition, so that electromagnetic waves of the two antennas do not superimpose within the housing.
